(19) United States
(12) Patent Application Publication
(10) Pub. No.: US 2013/0264391 A1
(43) Pub. Date: Oct. 10, 2013

(54) REFLECTIVE SURFACE HAVING A COMPUTER READABLE CODE

(71) Applicant: Miriam MERENFELD, Hollywood, FL (US)

(72) Inventor: Miriam MERENFELD, Hollywood, FL (US)

(21) Appl. No.: 13/856,472

(22) Filed: Apr. 4, 2013

Related U.S. Application Data
(60) Provisional application No. 61/620,137, filed on Apr. 4, 2012.

(51) Int. Cl. G06K 19/06

(52) U.S. Cl. CPC G06K 19/06037
USPC 235/494; 451/28; 264/1.37; 216/24

(57) ABSTRACT

A reflective surface has a digital code comprising specular reflective and diffuse reflective areas. The digital code can be a one or two dimensional code such as a bar code or a QR code. The digital code is created by beginning with a polished surface texture having a highly specular reflective quality and modifying the surface texture to create areas of more diffuse reflectivity. The areas of specular and diffuse reflectivity can be read as a digital code by code reading equipment while having a substantially uniform color thereby enhancing the application of digital codes to ornamental objects such as metallic jewelry.

### CROSS REFERENCE TO RELATED APPLICATION

This application claims the benefit of priority to U.S. Provisional Patent Application No. 61/620,137, filed on Apr. 4, 2012, the content of which is hereby incorporated in its entirety.

### FIELD OF THE INVENTION

This invention relates to optical machine-readable images or codes provided in a reflective or polished material without the use of black or colored resins.

### BACKGROUND

Optical machine-readable codes, such as barcodes and matrix codes, store data which are readable by an optical scanner. Barcodes are comprised of a series of vertically aligned black or colored bars of varying width. Barcodes are commonly applied to a product by applying ink or another dark colored light absorbing resin to a white light reflecting label and affixing the label to the product. In order for an optical scanner to properly read the code, the code must have a light absorbing color contrast with the light reflecting background. The black resin used to apply the code will be offset to the white background, thereby permitting an optical scanner to read the variable reflection of light between the white and black backgrounds. More recently, two-dimensional matrix codes have been developed which provide rows of horizontally and vertically aligned blocks or cells. Color contrasts presented by such bar codes and matrix codes detracts from potential ornamental applications where aesthetics is an important, including jewelry, mirrors and other metallic or glass applications.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein;

FIG. 1 is a front view of a known pendant of the prior art with an example matrix code applied in a black resin;

FIG. 2 is a front view of a pendant with an etched negative of an example multi-layer matrix code;

FIG. 3 is an exploded front view of the pendant of FIG. 2 showing the first and second layers of the multi-layer matrix code;

FIG. 4 is a front view of the pendant of FIG. 2 with the polished surfaces shaded in black;

FIG. 5 is a side view of the pendant of FIG, 2 with an optical scanner placed within proximity of the readable multi-layer matrix code;

FIG. 6 is a side view of the pendant of FIG. 5, with a transparent material provided between the scanner and the code; and

FIG. 7 is a side view of the code and surface of FIG, 6 with a tinted material provided between the scanner and the code.

### DETAILED DESCRIPTION OF THE DISCLOSURE

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

Color contrast optically readable digital codes occur when two contrasting colors are arranged is such a way as to form a one dimensional code such as a bar code or a two dimensional code such as a QR code. The contrasting colors typically have a large variation in light absorption. For example, black and white: black has a high level of color absorption while white has a low of color absorption. Typically bar codes comprise black lines printed on a white background. Instead of black and white, other contrasting colors can be used for bar and QR codes, for example, “dark gray” is a first color that has more light absorption than a second color of “light gray”. Dark gray and light gray are therefore contrasting colors. However, contrasting colors detract from potential ornamental applications such as jewelry where aesthetics is an important factor, Given the high color contrast of the typical black and white bar codes or QR codes, the specular and diffuse reflective surface texture characteristics are typically incidental. However, where high color contrast is undesirable, the one and two dimensional codes can be advantageously implemented by modification of the surface reflective characteristics without modification of the surface color.

A “specular reflection” is a reflection of light where the angle of incidence equals the angle of reflection. A “diffuse reflection” scatters incident light over a range of directions. Thus, if a light beam from a code scanning device impacts an area with a high level of specular reflection, the light will typically be reflected in such a way that it does not reflect back to the reader of the code scanning device, However, when the light beam impacts an area with a high level of diffuse reflection, the beam is scattered, with some of the beam scattering being reflected back towards the code scanning device. Thus, one and two dimensional digital codes can be read on a surface having variable specular and diffuse reflection areas, with areas of higher diffuse reflection appearing brighter to a code reader having an integral light source. Variable specular and diffuse reflection areas provide for a more ornamental optically readable digital code, because contrasting colors or light absorption characteristics are not required. Surface texture can be modified to produce areas of differing specular and diffuse reflection. For example a metallic surface has an area that may be polished to a gloss, which has a high level of specular reflection and a low level of diffuse reflection. Then the surface texture may be modified to a higher level of diffuse reflection, of roughened to a more of a matte finish to implement the digital code. The result is a first plurality of areas having a glossier surface texture or first level of specular reflection and a first level of diffuse reflection, and a second plurality of areas having a more matte surface texture or a second level of specular reflection less than the first level of specular reflection and a second level of diffuse reflection greater than the first level of diffuse reflection, the first and second plurality of areas arranged to produce the optically readable digital code.

The colors of the first and second areas are not necessarily changed by the modification of surface texture, Thus, a surface area having a color and an optically readable digital code comprises a first plurality of areas having a color and a first level of gloss and a second. plurality of areas having substantially the same color and a second level of gloss less than the first level of gloss, the first and second plurality of areas arranged to produce the optically readable digital code.

The description includes a method of producing an object having a surface having an optically readable digital code having a first plurality of areas having a first level of specular reflection and a first level of diffuse reflection, and a second plurality of areas having a second level of specular reflection less than the first level of specular reflection and a second level of specular diffuse greater than the first level of diffuse reflection, the first and second plurality of areas arranged to produce the optically readable digital code, the method comprising: polishing surface including the first plurality of areas and the second plurality of areas to a surface texture having first level of gloss; and modifying the surface texture of the second areas to have a reduced level of gloss.

With reference to the Figures, and in accordance with the disclosure, a multi-layer readable code is provided on a reflective surface or polished surface. The multi-layer code is comprised of a first layer having a first plurality of areas having a gloss or polished surface and a second layer having a second plurality of areas having an unpolished or matte surface. The second layer may be referred to as the negative of the multi-layer code, which is to be understood as the area immediately surrounding the readable area of the code. One dimensional multi-layer codes include bar codes having both continuous and discrete bars of single or varying widths and include UPC bar codes, for example. Two dimensional multi-layer codes contemplated include, for example, aztec code, data matrix, QR CODE, shot code, and maxi code. It should be understood, however, that the multi-layer code of the present disclosure is not limited to these examples and may include any optically readable code known or to be developed. It should be further understood that an optically scannable multi-layer message, such as a binary, alphanumeric, or another pictographically representation may be provided in place of or in addition to a computer scannable multi-layer code.

A gloss or polished surface is contemplated within the disclosure to include any surface having an optically enhanced specular reflective property. An optically enhanced specular reflective property is intended to include surfaces having a high gloss, sheen, or luster value. Such surfaces are typically smooth as well, In one advantageous embodiment, the polished surface is a metal or precious metal. Other polished surfaces, however, are contemplated within the disclosure including, but not limited to: glass, plastics, minerals, and precious and semiprecious jewels so long as the material is reflective or has a reflective backing, Any method of polishing surfaces known to a person of ordinary skill or yet to be developed in the art is contemplated within the disclosure. It should be appreciated that a multi-layer code may also be applied to a surface which light passes through, such as glass, plastics, minerals, precious and semiprecious stones.

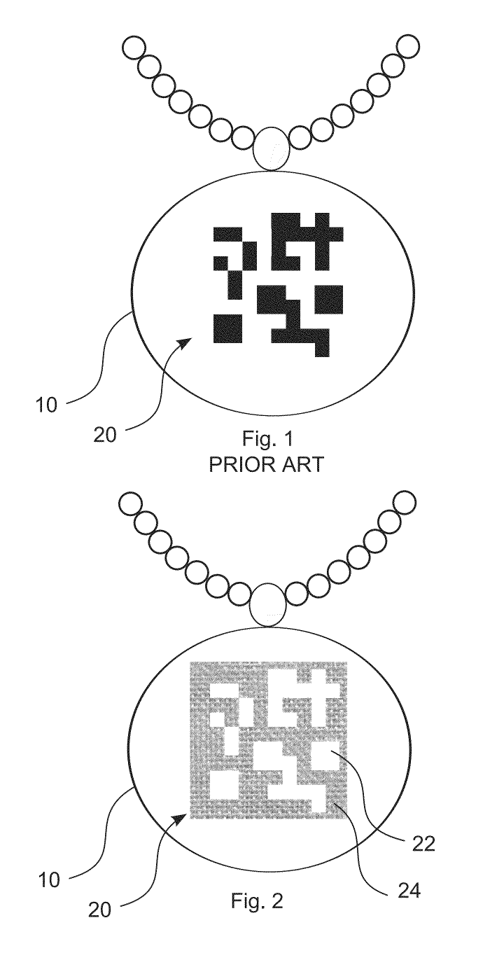

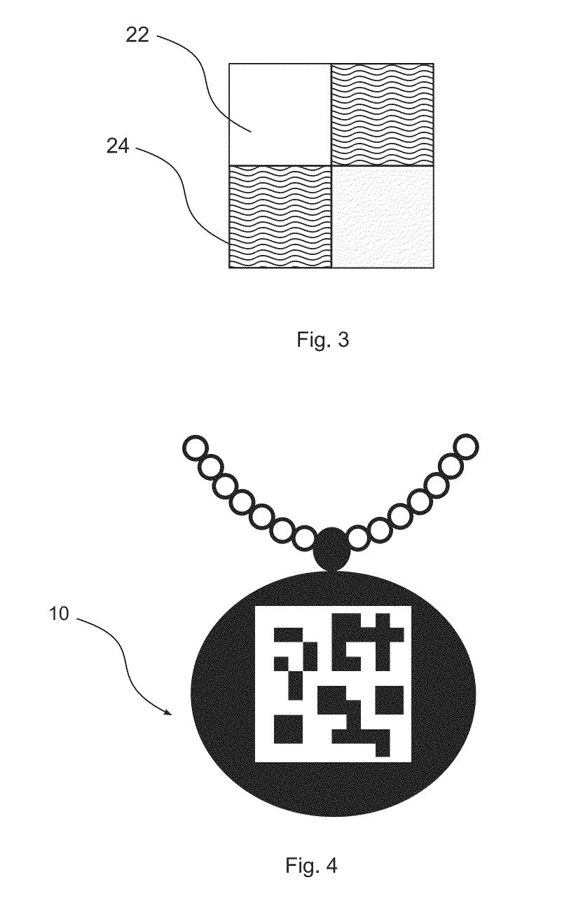

Referring now to FIGS. 2-5, an embodiment of the disclosure comprises an object 10, shown as an article of jewelry such as a pendant to be worn as part of a necklace or bracelet, including a polished or highly specularly reflective surface, which may be a metallic surface including elements of at least one of gold, silver, platinum, nickel, and copper, and at least a portion of the object 10 is provided with a multiple area multi-layer two-dimensional matrix code 20. Two-dimensional matrix code 20 is comprised of a first polished layer 22 and a second dull or matte layer 24. Object 10 comprises a surface having an optically readable digital code 20 comprising a first plurality of areas 22 having a first level of specular reflection and a first level of diffuse reflection, and a second plurality of areas 24 having a second level of specular reflection less than the first level of specular reflection and a second level of specular diffuse greater than the first level of diffuse reflection, the first and second plurality of areas arranged to produce the optically readable digital code.

In an advantageous embodiment, a second plurality of areas or layer 24 of code 20 is placed or inserted into, or provided on, the portion of object 10 that is to hold or include code 20. Thus, in one implementation second layer 24 is recessed from the surface of object 10 and has a dull or matte layer, as opposed to the original polished or reflective surface. First plurality of areas or layer 22 of code 20 is comprised of the unaltered reflective surface of object 10, The entire code 20 is thus comprised of the second applied layer 24 and immediately surrounding polished surface of object 10 defined as first layer 22. In other implementations second layer 24 is not necessarily recessed from the surface of object 10.

While it is advantageous that first layer 22 is comprised of an area of the polished surface of the object 10, thereby reducing the treatment of the object required to apply code 20, an additional embodiment in accordance with the disclosure features first layer 22 having its own surface displaced from the surface of object 10. For example, first layer 22 may be receded or recessed from the surface of object 10, so long as the surface of first layer 22 is more specularly reflective or glossy and the surface of second layer 24 is more diffusely reflective, or dull/matte.

In accordance with the disclosure, a polished surface 10 is either mechanically or chemically treated along second layer 24 so as to remove the polished finish of the material from which the pendant 10 is formed from. This finish removal process advantageously results in second layer 24 having a dull or matte surface while the polished surface remains along first layer 22. In an advantageous method for applying the multi-layer readable code 20, the second layer, or negative of the code, is etched, engraved, scratched with an article such as an abrasive, or dulled onto a portion of a polished surface. Any known or to be discovered method of etching, engraving, scratching or dulling a polished surface is contemplated within the disclosure. In an advantageous embodiment, a laser tool is utilized to precisely engrave a negative pattern of code 20 into a polished metal surface, thereby creating a matte second layer 24 offset from first layer 22. In another advantageous embodiment, a CNC machine is utilized to remove the polished material along second layer 24 thereby leaving second layer 24 with a dull or matte finish and offset from first layer 22. As opposed to mechanically treating the surface, in an embodiment second layer 24 is chemically treated in order to create the dulling or matte effect. For instance, a known or to be developed wax, plastic or other protective layer may be selectively applied over the portion of the polished. surface 10 comprising first layer 22 while leaving second layer 24 exposed to be chemically treated. An acidic, corrosive, or other surface removing treatment is then applied onto the area to comprise second layer 24. An example method of applying the chemical treatment includes stamping, spreading, painting, dipping, or spraying the treatment across the polished surface 10, it should be understood that the distance which the surface of the first layer 22 is offset or recessed from second layer 24, determined by the amount of surface material 10 removed in creating layer 24, may be either microscopic or macroscopic. This surface layer separation may be any suitable distance, depending on the size of code 20 and the area of the polished surface 10. Where the embodiment is of a pendant 10 of about 10 to 50 cm in diameter, for example, the recess distance may be advantageously less than 10 mm. However, it should be understood that providing a substantially larger or smaller, or no recess distance is a design choice because only a dulling or light scratching of the polished surface is required to provide second layer 24 in accordance with the disclosure.

In accordance with the disclosure, an advantageous improvement over known polished materials provided with a two-dimensional bar code, such as the pendant illustrated in FIG. 1, where a two-dimensional code is applied to a pendant by applying a black or colored resin over the area of the pendant in the pattern of the readable code. This method is less desirable for manufacturers of jewelry and other ornamental products as the use of a black or colored contrast against an expensive semi-precious metal yields an inferior looking product. it is thus advantageous to provide the multi-layer code 20, in accordance with the disclosure, without employing the use of any black or colored resins or markings. An ornamental product in accordance with the disclosure features a much more professional and desirable appearance, while still readable by a bar code scanner, such as cameras using barcode interpreting software; a feature of many modern cellular phones.

With reference to FIG. 4, the high specular reflective and low diffuse reflective portions of pendant 10, are shown in black and correspond to the areas having a gloss or polished surface. The low specular reflective and high diffuse reflective portions of pendant 10, are shown in white and correspond to the areas having a matte surface. If pendant 10 is a gold pendant, both areas shown in black and white will have a gold color and will have substantially the shade or same light absorption characteristics, but will have different gloss surface textures.

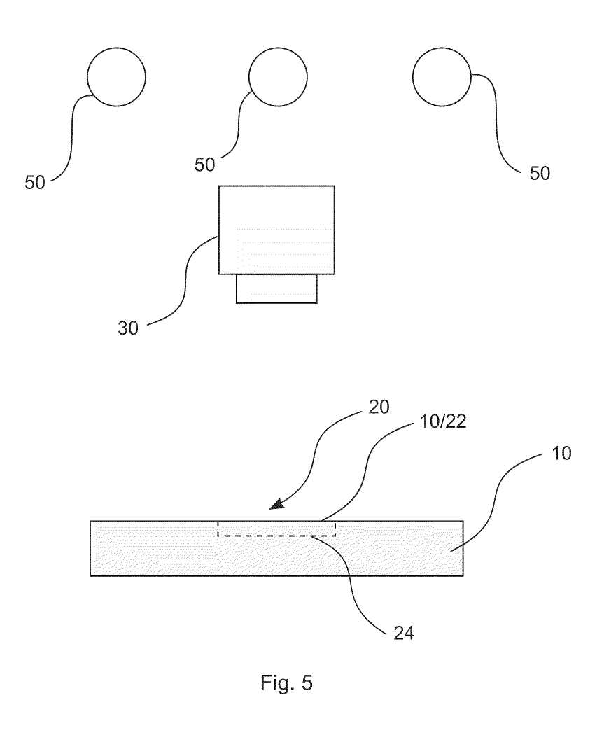

Referring now to FIG. 5, pendant 10 is placed below a device for optically reading the digital code, or an optical bar code reader 30 or camera equipped with barcode reading software. At least one light source 50 is then provided over the pendant, thereby creating a reflection off of pendant 10. Light source 50 may be a scanning laser emitted by code reader 30. if code reader is perpendicular to pendant 10, first layer 22 is reflected into the camera. However, if code reader is not perpendicular, which is a typical situation, light from the first layer is reflected away from the camera and appears as a darker area to the camera, while second layer 24 diffusely reflected back to the camera and appears as a lighter area to the camera.

Inversely, if a camera is used without a scanning laser, areas 22 may appear lighter than areas 24 and the camera can be used as a bar code reader using ambient light. It is advantageous that a focused light source is not required with the present invention, rather commonly found environmental lighting is sufficient to render an embodiment operable. Further, regardless or the source or location of light, the same code is read.

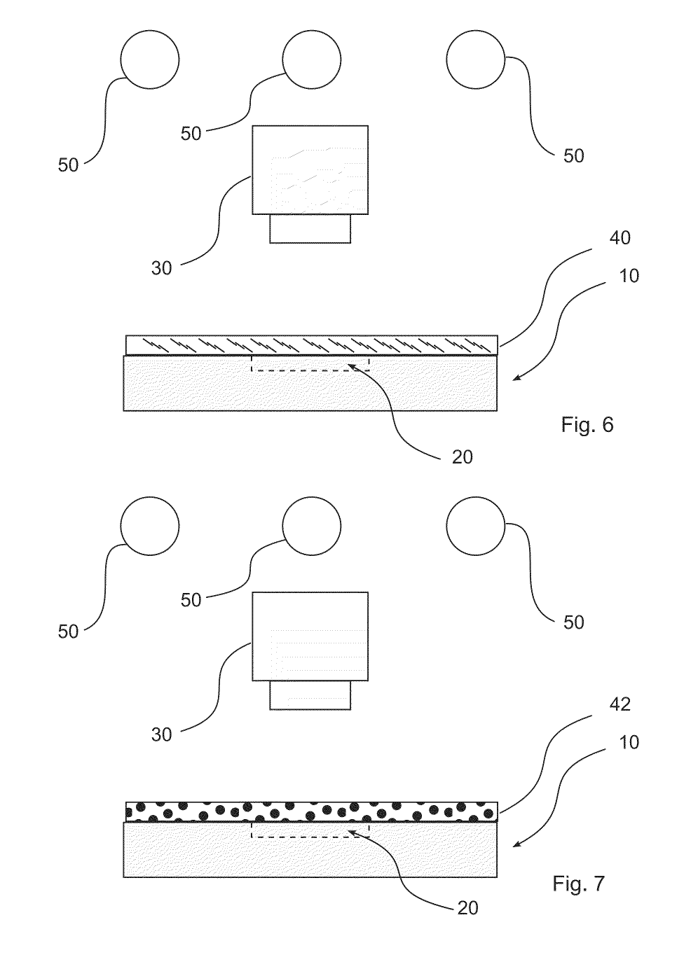

FIG. 6 illustrates an additional advantageous embodiment where a layer of transparent or translucent material 40 is provided between surface 10 and scanner 30. Here, light is transmitted through material 40 and may be read by scanner 30. Transparent material 40 may include any material which light passes through including, but not limited to, glass, jewels, minerals, and liquids. As an example application, it is contemplated within the disclosure that code 20 may be provided on a window, mirror, or below a liquid surface such as at the base of a pool.

Referring now to FIG. 7, in an advantageous embodiment according to the disclosure, a layer of tinted material 42 is provided between surface of object 10 and an image-enhancing scanner 30 operable to detect near infrared light. Because multi-layer code 20 is advantageously detected from light reflected from a polished surface instead of a white background, as opposed to detecting the lack of reflection from a darkened or colored resin, enhanced scanner 30 is able to detect low wave length light reflections from first layer 22, contrasted against second layer 24, undetectable by the naked eye.

Additionally, because light is specularly reflected off a polished surface, and not simply off a white background as commonly understood in the art, a wider range of colors and tints may be utilized in conjunction with the multi-layer code 20. A white background against a black code, as utilized in the prior art, is optimal because the white reflects the full spectrum of visible light while the black absorbs the full spectrum of visible light, thus providing a high contrast and an easy to read code. In an advantageous embodiment of the disclosure, however, each layer has similar light absorption characteristics and specularly or diffusely reflects substantially the same colored light spectrum. This may occur in embodiments where the first layer 22 and second layer 24 are the same color, or in embodiments where a uniformly colored, tinted material 42 is provided over multi-layer code 20, such as the embodiment illustrated in FIG. 7. In these advantageous embodiments, the code is invisible or nearly invisible to the naked eye because of the uniform color appearance across code 20, but when a light source is directed to the code 20, the optical scanner will still be able to detect and read the code. This embodiment permits a readable code to be provided on a tinted mirror for example, which is an advantageous security feature and an improvement over the prior art. Here, the bar code reader has an infrared range and the first level of specular reflection, the first level of diffuse reflection, the second level specular reflection and the second level of diffuse reflection are determined within a spectral range of a device for optically reading the digital code. Beyond the infrared range, the specular and diffuse reflective areas may have substantially the same characteristics, making the code more obscure to the human eye.

Although a pendant 10 bearing a multi-layer optically readable digital code 20 is illustrated in the figures, it will be appreciated that a variety of applications and uses are contemplated for a multi-layer readable code, in accordance with the disclosure, including but not limited to providing the code on production lines, at access points, on additional not specifically disclosed ornamental items, and any other known or to be developed object which might advantageously include an optically readable code. For example, an industrial application is the use of such codes on assembly line produced products such as soda cans, the variable reflectivity allows the code to be placed on a metallic surface or colored surface of the can. Similarly, code 20 can be placed on machinery, glass and other industrially produced items, and its application is not limited to jewelry.

The computer readable code applied to jewelry has numerous applications. For example, it can identify the owner of the jewelry, and if lost the owner can be found using the identification information. The computer readable code can have a URL, pointing to data associated with the jewelry, or can include the data itself, such as the contact information of the owner. In another example, memorial jewelry using QR codes can be distributed at or in association with a funeral and the QR can facilitate access to slide shows and historical facts associated with the deceased, which may either be represented as a URL or the actual data incorporated in the QR code itself.

It will be appreciated by persons skilled in the art that the present disclosure is not limited to what has been particularly shown and described herein above, A variety of modifications and variations are possible in light of the above teachings without departing from the scope and spirit of the disclosure. All references cited herein are expressly incorporated by reference in their entirety. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the scope of the disclosure might occur to those skilled in the art to which the disclosure pertains. Accordingly, all expedient modifications readily attainable by one versed in the art from the disclosure set forth herein that are within the scope of the present disclosure are to be included as further embodiments of the present disclosure.

What is claimed is:

1. An object comprising a surface having an optically readable digital code comprising:
a first plurality of areas having a first level of specular reflection and a first level of diffuse reflection; and
a second plurality of areas having a second level of specular reflection less than the first level of specular reflection and a second level of diffuse reflection greater than the first level of diffuse reflection, the first and second plurality of areas arranged to produce the optically readable digital code.

2. The object according to claim 1 wherein the first plurality of areas and the second plurality of areas have substantially similar light absorption characteristics,

3. The object according to claim 2 wherein the first plurality of areas have a glossier surface texture than the second plurality of areas.

4. The object according to claim 1 wherein the object has a metallic surface and first plurality of areas have a gloss surface texture and the second plurality or areas have a matte surface texture and the first plurality of areas and the second plurality of areas have substantially similar light absorption characteristics.

5. The object according to claim 4 wherein the metallic surface includes elements of at least one of gold, silver, platinum, nickel, and copper.

6. The object according to claim 5 wherein the object further includes a coating over the first plurality of areas and the second plurality of areas.

7. The object according to claim 6 wherein the coating is tinted or colored.

8. The object according to claim 1 wherein the optically readable digital code includes a bar code.

9. The object according to claim 1, wherein the optically readable digital code includes a two dimensional matrix code.

10. The object according to claim 1 wherein the first level of specular reflection, the first level of diffuse reflection, the second level specular reflection and the second level of diffuse reflection are determined within an spectral range of a device for optically reading the digital code.

11. A method of producing an object having a surface having an optically readable digital code having a first plurality of areas having a first level of specular reflection and a first level of diffuse reflection, and a second plurality of areas having a second level of specular reflection less than the first level of specular reflection and a second level of specular diffuse greater than the first level of diffuse reflection, the first and second plurality of areas arranged to produce the optically readable digital code, the method comprising:
polishing surface including the first plurality of areas and the second plurality of areas to a surface texture having first level of gloss; and
modifying the surface texture of the second areas to have a reduced level of gloss.

12. The method according to claim 11 wherein the step of modifying includes laser etching.

13. The method according to claim 11 wherein the step of modifying includes chemical etching.

14. The method according to claim 11 wherein the step of modifying includes abrasive etching.

15. The method according to claim 11 further comprising the step of applying a coating over the first plurality of areas and the second plurality of areas.

16. A surface area having a color and an optically readable digital code comprising:
a first plurality of areas having the color and a first level of gloss; and
a second plurality of areas having the color and a second level of gloss less than the first level of gloss, the first and second plurality of areas arranged to produce the optically readable digital code.

17. The surface area according to claim 16 wherein the surface area is included upon an article of jewelry and the color corresponds to a metallic surface of the jewelry.

18. The surface area according to claim 16 wherein the first plurality areas have first surface texture and the second plurality of areas have a surface texture different from the first plurality of areas.

19. The surface according to claim 16 further comprising a coating over the, first plurality of areas and the second plurality of areas.

20. The surface according to claim 16 wherein the optically readable digital code includes a two dimensional matrix code.
